(19) United States
(12) Patent Application Publication
(10) Pub. No.: US 2021/0400180 A1
(43) Pub. Date: Dec. 23, 2021

(54) FOCUS DETECTION DEVICE AND FOCUS DETECTION METHOD

(71) Applicant: Olympus Corporation, Hachioji-shi (JP)

(72) Inventor: Yoshinobu OMATA, Hachioji-shi (JP)

(21) Appl. No.: 17/323,946

(22) Filed: May 18, 2021

(30) Foreign Application Priority Data
Jun. 23, 2020 (JP) 2020-108117

(51) Int. Cl. H04N 5/235; H04N 5/243; H04N 5/232; G06T 7/80

(52) U.S. Cl. CPC H04N 5/2351; H04N 5/243; G06T 2207/10032; G06T 7/80; H04N 5/23212

(57) ABSTRACT

A focus detection device, comprising a processor having a brightness value detection section, an evaluation value calculation section, a parameter calculation section, a reliability determination section and a control section, wherein the brightness value detection section detects brightness values of pixels within a given evaluation region based on the image data, the evaluation value calculation section calculates evaluation values based on the brightness values, the parameter calculation section calculates parameters representing degree of symmetry of the evaluation values for positions of the focus, the reliability determination section determines reliability based on the parameters, and the control section performs focus detection based on extreme values that are calculated based on the parameters, and the reliability.

### CROSS-REFERENCE TO RELATED APPLICATIONS

Benefit is claimed, under 35 U.S.C. § 119, to the filing date of prior Japanese Patent Application No. 2020-108117 filed on Jun. 23, 2020. This application is expressly incorporated herein by reference. The scope of the present invention is not limited to any requirements of the specific embodiments described in the application.

### BACKGROUND OF THE INVENTION

### 1. Field of the Invention

The present invention relates to a focus detection device and a focus detection method that are capable of focusing on a subject such as a point light source that is at an infinity end at the time of starry scene shooting.

### 2. Description of the Related Art

In a case where the subject is astral bodies, such as stars, then since astral bodies are dark focus adjustment using a focus adjustment device is difficult. There have therefore been various proposals for focus detection methods for focusing on stars. For example, in Japanese patent application No. 6398250 (hereafter as “patent publication 1”) there is disclosed a method of, while moving a focus controller in an optical axis direction, recognizing a specific astral body image from images that have been formed by an image sensor, detecting size on the image sensor for the astral body image that has been recognized, detecting a minimum value of image size for specific astral body images that have been detected at each position, and making a focus lens position corresponding to the minimum value that has been detected an in-focus position.

Also, Japanese patent laid-open No. 2018-72554 (hereafter referred to as “patent publication 2”) discloses a method that makes use of symmetry of AF evaluation values in the vicinity of an in-focus position, and involves calculating a plurality of AF evaluation values using brightness signals within an AF area while moving focus in an optical axis direction, and detecting a position of an inflection point for symmetry of the AF evaluation values as an in-focus position.

There have been various proposals like this for focus adjustment devices applied to the shooting of starry scenes etc. However, there are problems to be addressed, as follows. Specifically, a conventional focus detection device is subject to the influence of flickering due to atmospheric air currents and the effects of disturbances, and brightness signals change over time, which means that AF evaluation values fluctuate and detection precision of focus points based on symmetry matching processing is lowered, and focusing becomes somewhat loose. There is also a problem of lowering of in-focus position precision due to the lowering of detection precision, and significant increase in time required for detection of in-focus position, as well as lens drive and image acquisition being performed unnecessarily.

### SUMMARY OF THE INVENTION

The present invention provides a focus detection device and focus detection method that are capable of preventing reduction in in-focus position precision due to the influence of flickering caused by atmospheric air currents and the influence of disturbance, and that can suppress unnecessary lens drive and imaging, and perform in-focus position detection at high speed.

A focus detection device of a first aspect of the present invention, that acquires a plurality of image data while changing focus, and performs focus detection based on the image data, comprises a processor having a brightness value detection section, an evaluation value calculation section, a parameter calculation section, a reliability determination section, and a control section, wherein the brightness value detection section detects brightness values of pixels within a given evaluation region based on the image data, the evaluation value calculation section calculates evaluation values based on the brightness values, the parameter calculation section calculates parameters representing degree of symmetry of the evaluation values for positions of the focus, the reliability determination section determines reliability based on the parameters, and the control section performs focus detection based on extreme values that are calculated based on the parameters, and the reliability.

A focus detection method of a second aspect of the present invention, that acquires a plurality of image data while changing focus, and performs focus detection based on the image data, comprises detecting brightness values of pixels within a given evaluation region based on the image data, calculating evaluation values based on the brightness values, calculating parameters representing degree of symmetry of the evaluation values for positions of the focus, determining reliability based on the parameters, and performing focus detection based on extreme values that are calculated based on the parameters, and the reliability.

A non-transitory computer-readable medium of a third aspect of the present invention, storing a processor executable code, which when executed by at least one processor, the processor being arranged within a focus detection device that acquires a plurality of image data while changing focus, and performs focus detection based on the image data, performs a focus adjusting method comprising detecting brightness values of pixels within a given evaluation region based on the image data, calculating evaluation values based on the brightness values, calculating parameters representing degree of symmetry of the evaluation values for positions of the focus, determining reliability based on the parameters, and performing focus detection based on extreme values that are calculated based on the parameters, and the reliability.

### BRIEF DESCRIPTION OF THE DRAWINGS

FIG. 1A and FIG. 1B are block diagrams mainly showing the electrical structure of a camera of one embodiment of the present invention.

FIG. 2 is a flowchart showing shooting operation of the camera of one embodiment of the present invention.

FIG. 3 is a flowchart showing point light source AF operation of the camera of one embodiment of the present invention.

FIG. 4 is a flowchart showing exposure condition adjustment processing operation of the camera of one embodiment of the present invention.

FIG. 5 is a flowchart showing exposure condition setting processing operation of the camera of one embodiment of the present invention.

FIG. 6A and FIG. 6B are flowcharts showing operation of in-focus position detection processing of the camera of one embodiment of the present invention.

FIG. 7 is a graph for describing symmetry matching processing, in the camera of one embodiment of the present invention.

FIG. 8 is a graph for describing the fact that symmetry of AF evaluation values is detected based on symmetry matching processing, and in-focus position is detected, in the camera of one embodiment of the present invention.

FIG. 9 is a graph for describing detection of symmetry of AF evaluation values and determination of reliability in a case where in-focus position has been detected, in the camera of one embodiment of the present invention.

FIG. 10 is a graph for describing detection of symmetry of AF evaluation values and determination of reliability in a case where in-focus position has been detected, in the camera of one embodiment of the present invention.

FIGS. 11A-11D are graphs for describing detection of symmetry of AF evaluation values and determination of reliability in a case where in-focus position has been detected, in the camera of one embodiment of the present invention.

FIG. 12 is a table showing data that is stored as in-focus history information, in the camera of one embodiment of the present invention.

FIG. 13 is a flowchart showing operation of infinity end position acquisition in the camera of one embodiment of the present invention.

FIG. 14 is a flowchart showing operation of infinity end position registration in the camera of one embodiment of the present invention.

### DETAILED DESCRIPTION OF THE PREFERRED EMBODIMENTS

An example where a digital camera (hereafter simply called “camera”) is adopted as an imaging devices, as one embodiment of the present invention, will be described in the following. This camera has an imaging section, with a subject image being converted to image data by this imaging section, and the subject image being subjected to live view display on a display section arranged on the rear surface of the camera body based on this converted image data. A photographer determines composition and photo opportunity by looking at the live view display. At the time of a release operation image data is stored in a storage medium. Image data that has been stored in the storage medium can be subjected to playback display on the display section if playback mode is selected.

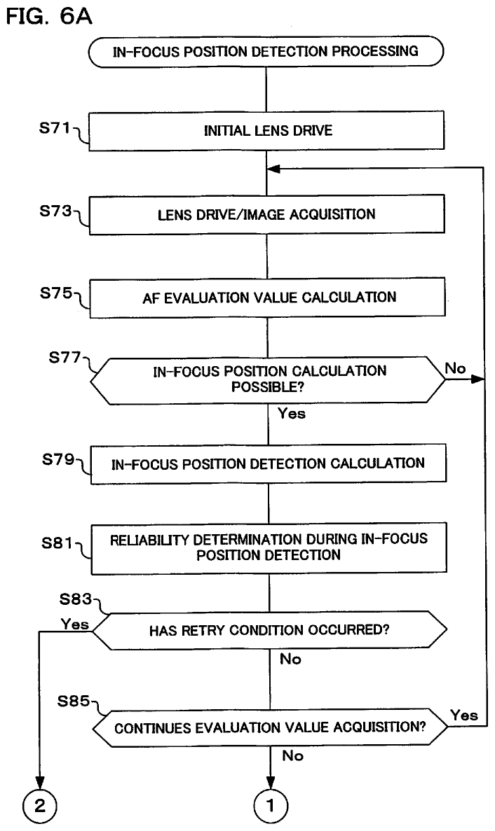

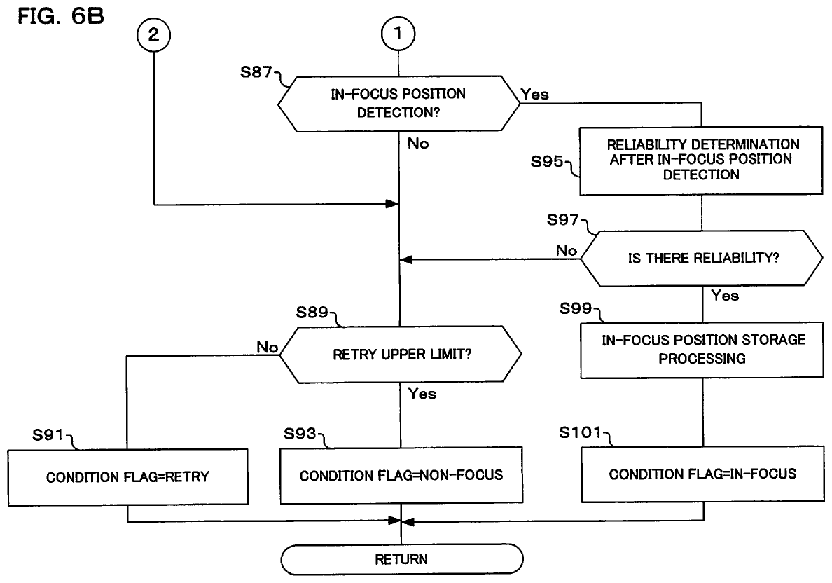

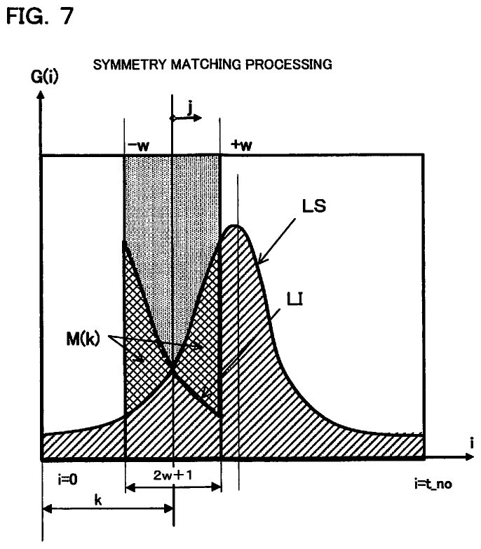

Also, with this embodiment, in order to focus on one or a plurality of point light sources, a plurality of image data are acquired while changing focus, for example, moving a focus lens in an optical axis direction, and focus detection is performed based on this image data. At the time of focus detection, AF evaluation values are calculated (refer to S75 in FIG. 6A), and focus adjustment is performed based on these AF evaluation values (refer to S73 and S75 in FIG. 6A, and S87 in FIG. 6B). Also, with this embodiment, in the case where in-focus position has been detected (S87 Yes in FIG. 6B), reliability is determined based on symmetry matching results (refer to S95 and S97 in FIG. 6B, and to FIG. 7 to FIG. 9), and AF precision is improved by utilizing results having high reliability while not using results of low reliability.

As a determination method for the reliability, a method is suitably selected from various methods such as (1) degree of coincidence of focus positions corresponding to a minimum value of symmetry matching results for a plurality of AF evaluation values, (2) degree of symmetry of symmetry matching results, and (3) degree of sharpness in the vicinity of a minimum value of symmetry matching result, and determination is performed using results that have been selected.

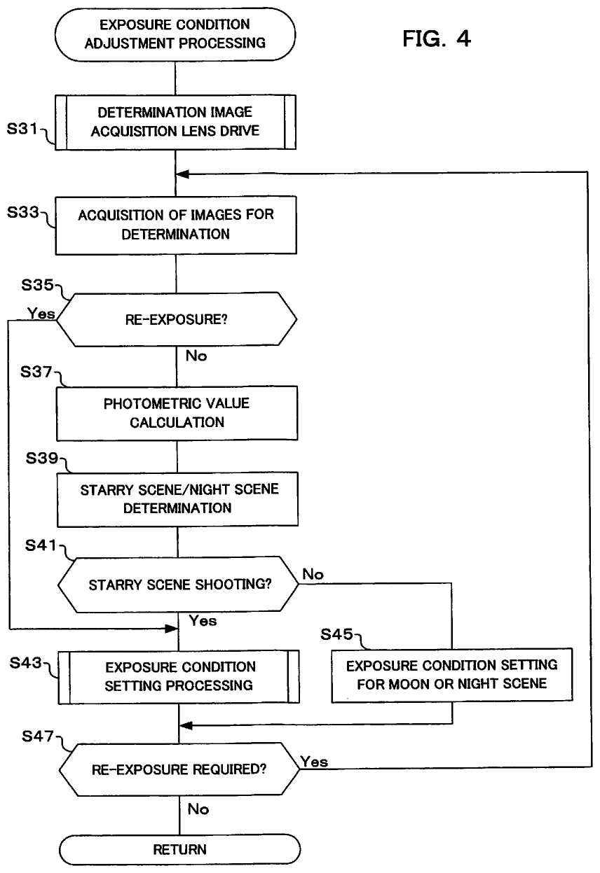

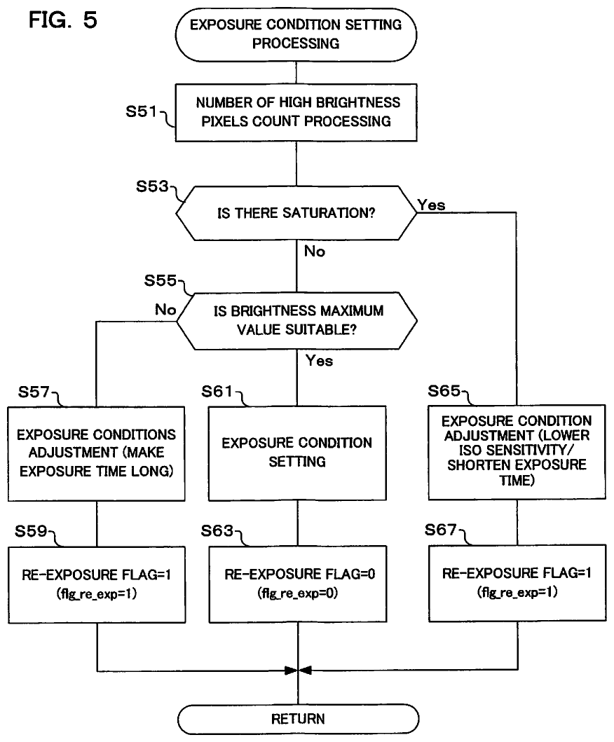

Also, with this embodiment, in a case where pixel data of image data for determination that is used in AF evaluation is not suitable, exposure conditions at the time of acquiring image data for determination are changed, so that the pixel data becomes within a suitable range (refer to S47 in FIG. 4, and to FIG. 5).

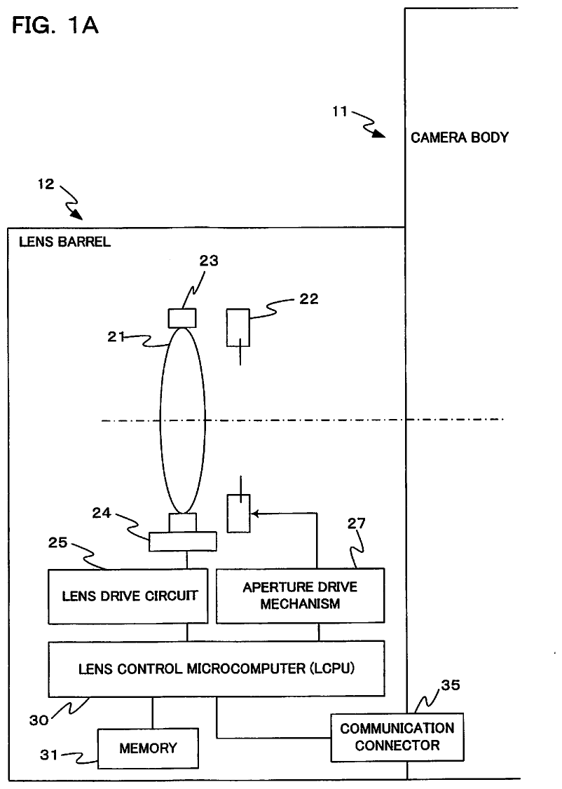

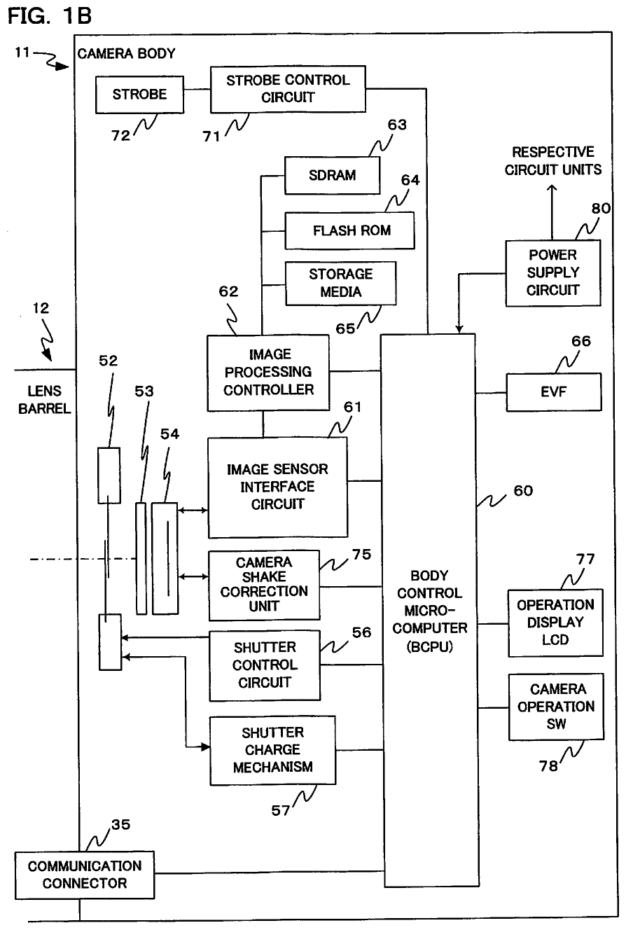

FIG. 1A and FIG. 1B are block diagrams mainly showing the electrical structure of a camera of this embodiment. This camera is constructed with a camera body 11 and a lens barrel 12 being separate, and the lens barrel 12 is detachable from the camera body 11. It should be noted that the camera body 11 and the lens barrel 12 may also be formed integrally.

A photographing lens 21 (containing a focus lens) for focus adjustment and focal length adjustment, and an aperture 22 for adjusting opening diameter, are arranged within the lens barrel 12. The photographing lens 21 is held in a lens frame 23, with the lens frame 23 being driven in an optical axis direction by a lens drive mechanism 24 and a lens drive circuit 25. The aperture 22 is driven by an aperture drive mechanism 27, and opening diameter of the aperture 22 is changed.

The lens drive circuit 25 and the aperture drive mechanism 27 are connected to a lens control microcomputer (hereafter referred to as “LCPU”) 30, and drive control is performed using the LCPU 30. The LCPU 30 is a processor having a CPU (Central processing unit) and peripheral circuits, not shown, such as a lens drive pulse generating section, and the CPU within the LCPU 30 controls each section within the lens barrel 12 in response to control instructions from the camera body 11 in accordance with a program that has been stored in a memory 31.

The LCPU 30 is connected to the memory 31. This memory 31 is an electrically rewritable non-volatile memory, such as flash ROM. As well as programs for the LCPU 30 described previously, the memory 31 stores various characteristics such as optical characteristics of the photographing lens 21, characteristics of the aperture 22 etc., and also stores various adjustment values. As optical characteristics of the photographing lens 21, the memory 31 has, for example, information relating to distortion of the photographing lens 21 etc. for every focal length. The LCPU 30 reads out and transmits these items of information from the camera body 11 as required.

The memory 31 functions as a storage section that stores various data of the photographing lens. This storage section stores various data in accordance with a plurality of optical states of the photographing lens (for example, for every focal length and every focus lens position).

The LCPU 30 is connected to a communication connector 35, and performs communication with a body control microcomputer (hereafter referred to as “BCPU”) within the camera body 11 by means of this communication connector 35. Also, the communication connector 35 has power feed terminals for supplying power from the camera body 11 to the lens barrel 12.

A shutter 52 for exposure time control is provided in the camera body 11, on the optical axis of the photographing lens 21. With this embodiment, the shutter 52 is provided with a focal plane shutter having a front curtain and a rear curtain, for example. The shutter 52 is subjected to shutter charge by a shutter charge mechanism 57, and opening and closing control of the shutter 52 is performed by a shutter control circuit 56.

An image sensor unit 54 is arranged behind the shutter 52, on the optical axis of the photographing lens 21, and a subject image that has been formed by the photographing lens 21 is photoelectrically converted to a pixel signal by an image sensor within the image sensor unit 54. It should be noted that as an image sensor it is possible to use a two dimensional image sensor such as a CCD (charge Coupled Device) image sensor or a CMOS (Complementary Metal Oxide Semiconductor) image sensor. The image sensor unit 54 includes an image sensor that receives subject light that has been condensed by the photographing lens, performs photoelectric conversion, and outputs a pixel signal. An array of color filters of the image sensor is a Bayer array, for example.

It should be noted that in the case where focus detection is performed for point light sources that are at the infinity end, such as stars, the image sensor performs readout of a pixel signal using all-pixel acquisition mode. As pixel acquisition mode there is thinning acquisition mode in which pixel data is acquired at pixel positions at predetermined intervals, and all-pixel acquisition mode where pixel data of all pixels is acquired. If the focus lens is moved brightness of stars becomes high near to a focus position, but with thinning acquisition mode where only pixel data at pixel positions at predetermined intervals is acquired, stellar images are liable to be lost near to the focus position. With this embodiment therefore, at the time of performing focusing for star images, all-pixel acquisition mode is executed.

An optical low pass filter (OLPF) 53, which is an optical filter for removing infrared light components and high-frequency components from subject light flux, is arranged between the previously described shutter 52 and image sensor unit 54.

The image sensor unit 54 is moved in a direction that counteracts camera shake, within a plane that is orthogonal to the optical axis of the photographing lens 21, by a camera shake compensation unit 75. Specifically, if the camera body 11 moves due to camera shake by the photographer, fluctuation amount and direction of this movement are detected by a shake detection section such as a Gyro (not illustrated), and the camera shake compensation unit 75 causes the image sensor unit 54 to move so as to counteract the movement that has been detected, in accordance with control from the BCPU 60.

The image sensor unit 54 is connected to an image sensor interface circuit 61. The image sensor interface circuit 61 reads out a pixel signal from the image sensor within the image sensor unit 54 in accordance with control commands from the BCPU 60, and after preprocessing, such as amplification processing and A/D conversion processing, has been applied outputs image data to an image processing controller 62.

The image processing controller 62 performs various image processing such as digital amplification of digital image data (digital gain adjustment processing), color correction, gamma (γ) correction, contrast correction, and image generation for live view display etc. Also, image data is compressed using a compression system such as JPEG or TIFF, and compressed image data is expanded. It should be noted that image compression is not limited to JPEG or TIFF, and other compression formats may be used.

An SDRAM (Synchronous Dynamic Random Access Memory) 63, flash ROM 64, and storage media 65 are connected to the image processing controller 62.

The SDRAM 63 is an electrically rewritable volatile memory, and performs temporary writing and reading out of image data that has been read out from the image sensor unit 54. The flash ROM 64 is an electrically rewritable non-volatile memory, and performs storage and readout of programs for the BCPU 60, and various adjustment values etc. The flash ROM 64 stores lens characteristics such as optical data that has been read out from the memory 31.

For the storage media 65, any storage medium that is capable of being rewritten, such as CompactFlash (registered trademark), SD memory card (registered trademark), or memory stick (registered trademark) can be loaded, and is put into and taken out of the camera body 11. Besides, it is also possible to have a configuration where it is possible to connect to a hard disc via a communication connection point.

A strobe 72 boosts a power supply voltage from a power supply circuit 80 and comprises a capacitor that is charged with this boosted high-voltage, a xenon flash tube for flash light emission, and a trigger circuit etc., and is used as a lighting device for low brightness subjects. A strobe control circuit 71 performs control of charging and triggering etc. of the strobe 72 in accordance with control commands from the BCPU 60.

An EVF (Electronic Viewfinder) 66 enables the photographer to observe a display panel built in to the camera body 11, by means of an eyepiece. The EVF 66 also has a display panel that is provided on the outside of the camera body 11, so that the photographer can directly view the display panel. Live view display and playback display of stored images etc. is performed on the EVF 66. An LCD (Liquid Crystal Display) for operational display is provided on the exterior of the camera body 11, and also performs display of operating states of the camera, and live view display and playback display of stored images.

The camera operation switch (SW) 78 is a switch linked to operation of operation members such as a power supply button, release button, menu button, OK button etc. A 1R switch (1RSW) that detects a half press operation of the release button, and a 2R switch (2RSW) that detects a full press operation of the release button are provided in the release button.

A power supply circuit 80 has a power supply battery fitted to the camera body 11, and supplies a power supply voltage to each of the circuit units within the camera body 11 and the lens barrel 12.

A body control microcomputer (BPCU) 60 is a processor that has a CPU (Central Processing Unit) and peripheral circuits etc. for the CPU. The BCPU 60 executes processing for the entire camera by controlling each section within the camera body 11 and, by means of the LCPU 30, each section within the lens barrel 12, in accordance with programs that have been stored in the flash ROM 64.

The BCPU 60 detects brightness value of pixels within an AF evaluation region AFVA (also called AF target), which will be described later, based on image data that is input by means of the image sensor interface circuit 61. Also, the BCPU 60 moves the focus lens and calculates AF evaluation values based on brightness values that have been acquired at respective lens positions. The BCPU 60 performs symmetry processing on AF evaluation values that have been acquired at a plurality of focus lens positions and calculates symmetry evaluation values (also called symmetry matching results). The BCPU 60 obtains in-focus position based on position of an extreme value for symmetry evaluation value, and moves the focus lens to this in-focus position.

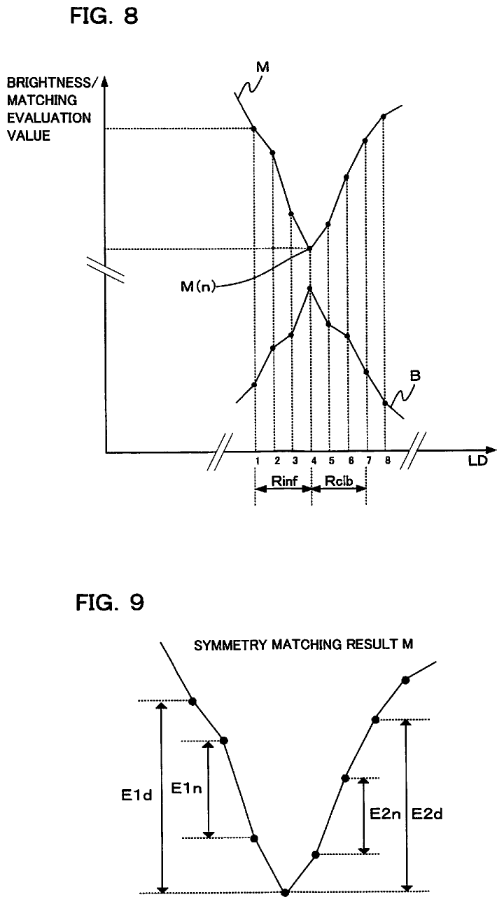

The BCPU 60 functions as a brightness value detection section that detects brightness values of pixels within a given evaluation region based on image data (refer, for example, to S37 in FIG. 4, and S73 in FIG. 6A). The BCPU 60 functions as an evaluation value calculation section that calculates evaluation values based on brightness values (refer, for example, to S75 in FIG. 6A). The BCPU 60 functions as a parameter calculation section that calculates parameters representing degree of symmetry of evaluation values for focus positions (for, for example, to S95 in FIG. 6B, and to FIG. 7). The BCPU 60 functions as a reliability determination section that determines reliability based on parameters (refer, for example, to S95 in FIG. 6B, and to FIG. 8 to FIGS. 11A-11D. The BCPU 60 functions as a control section that performs focus detection based on extreme values calculated based on parameters, and based on reliability (refer, for example, to S97 and S101 in FIG. 6B).

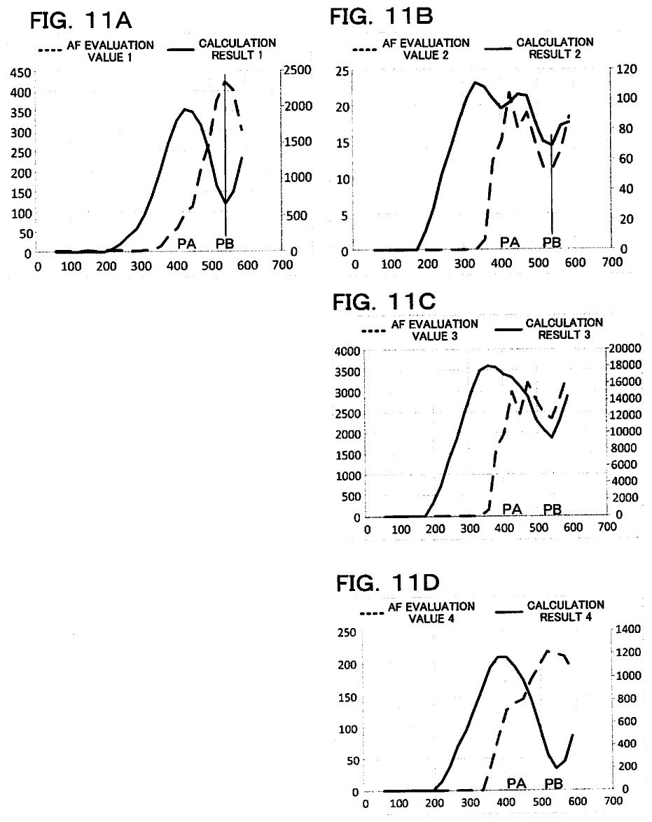

Also, the above described evaluation value calculation section calculates a plurality of different evaluation values based on brightness values, the parameter calculation section calculates a plurality of different parameters based on the plurality of different evaluation values, and the reliability determination section determines that there is reliability in the event that a difference between focus positions corresponding to extreme values calculated based on the plurality of different parameters is less than or equal to a predetermined value (refer, for example, to S95 and S97 in FIG. 6B, and to FIGS. 11A-11D).

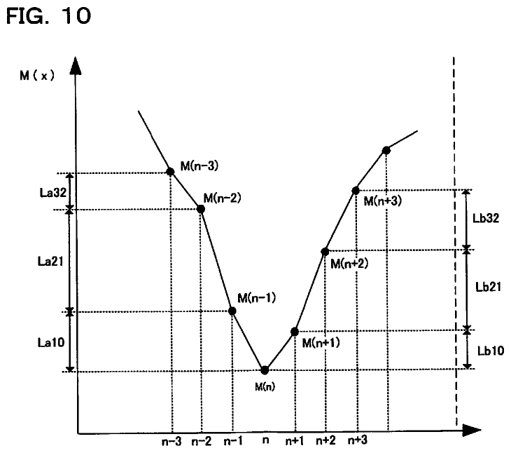

Also, the reliability determination section determines reliability based on degree of symmetry of extreme values of parameters for focus position (refer, for example, to S95 and S97 in FIG. 6B, and to FIG. 9). The reliability determination section determines reliability based on degree of change in the vicinity of extreme values of parameters for focus position (refer, for example, to S95 and S97 in FIG. 6B, and to FIG. 10). The control section continues operation to acquire a plurality of image data while changing focus when it is determined by the reliability determination section that reliability of some of the plurality of parameters is low (refer, for example, to S85 in FIG. 6A, S95 in FIG. 6B, and to FIGS. 11A-11D).

The evaluation values are brightness values representing maximum brightness within an evaluation region, a number of pixels that exceed a specified brightness value within an evaluation region, an integrated value of brightness values of pixels that exceed a specified brightness within an evaluation region, or a value derived by dividing an integrated value by a number of pixels that exceed a given brightness value (refer, for example, to S75 in FIG. 6A).

With this embodiment each of the above described functions is realized in the form of software by the BCPU 60. However, it is also possible for some or all of these functions to be realized by hardware circuits, and to have a hardware structure such as gate circuits that have been generated based on a programming language that is described using Verilog, and also to use a hardware structure that utilizes software such as a DSP (digital signal processor). These approaches may be appropriately combined. Also, the BCPU 60 is not limited to having a single processor and may comprise a plurality of processors, and various operations may be implemented by means of cooperation between these processors.

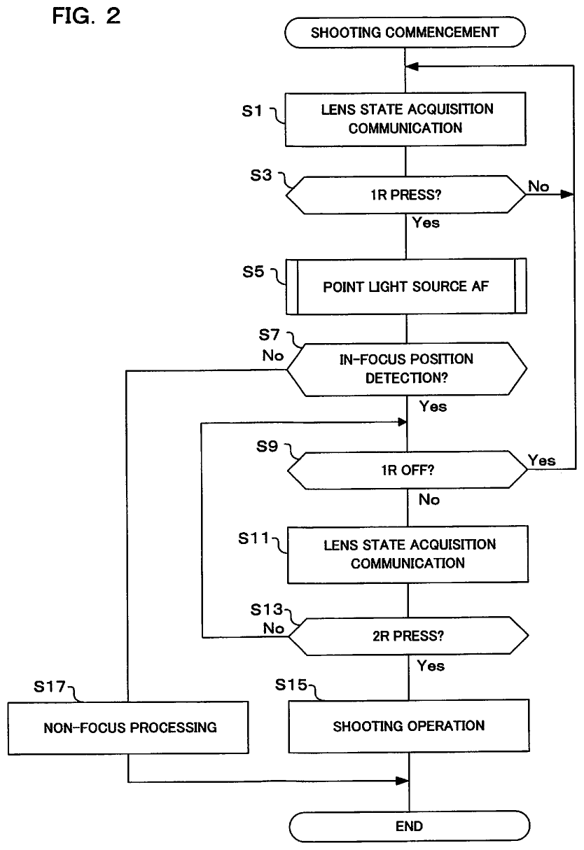

Next, shooting operation of the camera of this embodiment will be described using the flowcharts shown in FIG. 2 to FIG. 6B. This operation is executed by the BCPU 60 controlling each section of the camera in accordance with programs that have been stored in the flash ROM 64. Point light source AF processing, that includes AF control (also referred to as star AF) for a point light source that is at the infinity end, such as stars, is included in this shooting flow, and star AF control is performed if the AF mode is set to star AF mode. Here, description will be given for a case where star AF mode is set as the AF mode.

If the shooting flow shown in FIG. 2 is commenced, first, lens state acquisition communication is performed (S1). In this step, the BCPU 60 performs lens state acquisition communication with the photographing lens (LCPU 30 within the lens barrel 12), and the most recent lens states, such as most recent state of the aperture, most recent zoom state (including focal length) etc. of the photographing lens are acquired.

It is next determined whether or not a 1R press has been performed (S3). If the photographer has determined composition etc. the release button is pressed down halfway as a step before shooting. If this half press has been performed, the 1R switch within the camera operation SW78 is turned on. In this step the BCPU 60 determines whether or not the 1R switch has turned on. If the result of this determination is that the 1R switch is off (when the release button has not been pressed down halfway) processing returns to step S1.

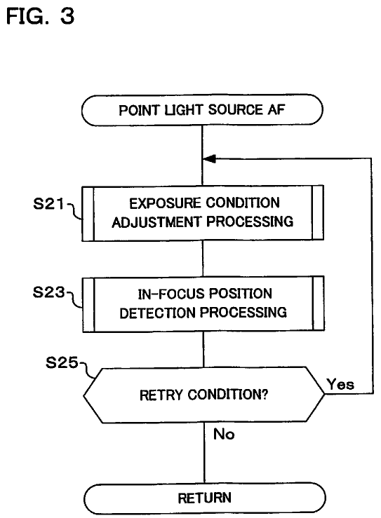

On the other hand, if the result of determination in step S3 is that the release button has been pressed down halfway, that is that the 1R switch being on is detected, point light source AF is executed (S5). In this step the BCPU 60 commences point light source AF and performs detection of in-focus position. In this step of point light source AF, setting of exposure conditions at the time of executing in-focus position detection may also be performed. Detailed operation of this point light source AF will be described later using FIG. 3.

Next, it is determined whether or not an in-focus position has been detected (S7). Here, the BCPU 60 determines whether or not it was possible to detect an in-focus position as a result of having executed point light source AF in step S5. As will be described later, in the event that it was possible to detect an in-focus position in-focus is set in a condition flag (S101 in FIG. 6B), while in the case of non-focus, non-focus is set in a condition flag (refer to S93 in FIG. 6B). Here, the BCPU 60 performs determination based on the condition flag.

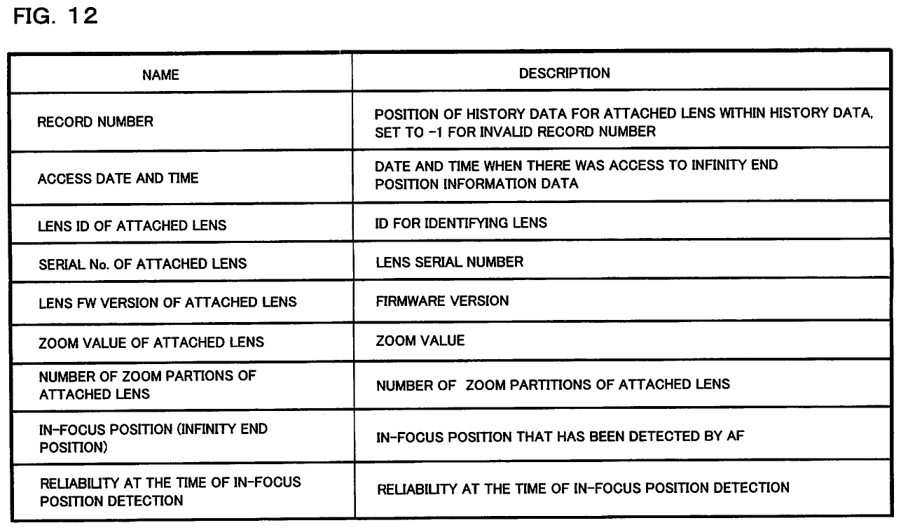

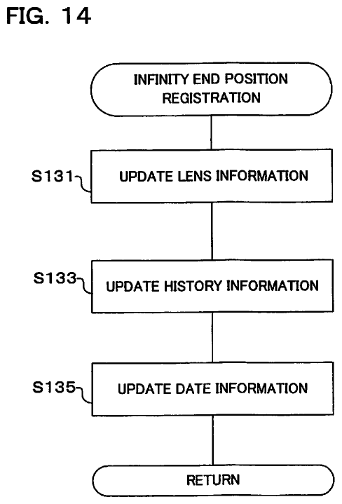

If the result of determination in step S7 is that it was not possible to detect an in-focus position, the BCPU 60 performs non-focus processing (S17). With non-focus processing, the lens is driven to a position that is registered in infinity end position registration information (refer to FIG. 12 and FIG. 14) in order to make it easy to perform framing etc. in preparation for the next shooting operation. Warning display for non-focus etc. is also performed. Once the non-focus processing is completed, if the power supply is on processing returns to step S1 and the previous operations are executed.

On the other hand, if the result of determination in step S7 is that an in-focus position has been detected, it is next determined whether or not 1R is off (S9). If the photographer intends to continue shooting after having pressed the release button down half way in step S3, they maintain the half pressing of the release button, but in cases such as where shooting is interrupted in order to change the composition etc. they remove their finger from the release button. In this step the BCPU 60 determines whether or not the 1R switch has turned off. If the result of this determination is that the 1R switch is off (when the release button has not been pressed down halfway) processing returns to step S1.

On the other hand, if the result of determination in step S9 is that the 1R switch is on, next, lens state acquisition communication is performed (S11). Here, the BCPU 60 performs lens state acquisition communication with the photographing lens, and notifies in-focus position to the photographing lens. If the LCPU 30 within the photographing lens receives notification of in-focus position, the lens is driven to this in-focus position. Also, since at this time there is focus on an astral body such as a star that is a subject at the infinity end, if infinity end position registration shown in FIG. 14 has not been performed the BCPU 60 may perform this infinity end position registration.

It is next determined whether or not a 2R press has been performed (S13). If the photographer determines composition etc. and determines that shutter timing is appropriate, the release button is pressed down fully. If this full press has been performed, the 2R switch within the camera operation SW78 is turned on. In this step the BCPU 60 determines whether or not the 2R switch has turned on. If the result of this determination is that the 2R switch is off (when the release button has not been pressed down fully) processing returns to step S9.

On the other hand, if the result of determination in step S13 is that there has been a 2R press, namely when the release button has been pressed down fully, a shooting operation is performed at (S15). In this step, the BCPU 60 performs a shooting operation for an image with exposure conditions that have been set in advance. Once the shooting operation is completed, if the power supply is on processing returns to step S1 and the previous operations are executed.

Next, operation of the point light source AF of step S5 (refer to FIG. 2) will be described using the flowchart shown in FIG. 3. The flow of this point light source AF includes star AF control.

If the flow for point light source AF shown in FIG. 3 is commenced, first, exposure condition adjustment processing is executed (S21). Here, the BCPU 60 determines exposure conditions for at the time of shooting an image (acquiring image data) in order to perform AF using point light source AF. As will be described later, when performing AF using point light source AF, in order to obtain high precision detection results it is preferable to acquire image data at the correct exposure. In this step, therefore, exposure conditions are adjusted so as to make it possible to obtain image data at the correct exposure. Detailed operation of this exposure conditions adjustment processing will be described later using FIG. 4.

Next, in-focus position detection processing is executed (S23). Here, the BCPU 60 acquires images for calculation of AF evaluation values while performing lens drive, and performs detection of in-focus position based on the calculated AF evaluation values. Detailed operation of this in-focus position detection procedure will be described later using FIG. 6A and FIG. 6B.

If in-focus position detection processing has been performed, is next determined whether or not there is a retry condition (S25). In the in-focus position detection processing of step S23 a cause of retry occurs when saturated pixels, which will be described later, are detected in an image for determination, and retry is set in a condition flag (refer to S83 and S91 in FIG. 6B). Retry is also set in a condition flag in a case where it was not possible to detect an in-focus position (refer to S87 No and S91 in FIG. 6B). In this step, the BCPU 60 determines whether or not there is a retry condition based on the condition flag.

If the result of determination in step S25 is that it has been determined that there is a retry condition, processing returns to step S21, exposure conditions are changed (S57 and S65 in FIG. 5), and the in-focus position detection processing of step S23 is performed again. Changing of exposure conditions and in-focus position detection processing (refer to S23) is repeated until a retry condition is no longer satisfied (a retry cause does not occur). If it has been determined in step S25 that there is no retry condition, the processing for point light source AF is completed and the originating flow is returned to. It should be noted that determination that there is no retry condition is either a case of being in-focus (S101 in FIG. 6B)) or the case where non-focus has been determined (S93 in FIG. 6B). Also, as a modified example step S23 may be returned to if it has been determined in step S25 that there is a retry condition. In this case the exposure conditions are not changed and the in-focus position detection processing is executed again in step S23 with the same exposure conditions.

Next, operation of the exposure condition adjustment processing of step S21 (refer to FIG. 3) will be described using the flowchart shown in FIG. 4.

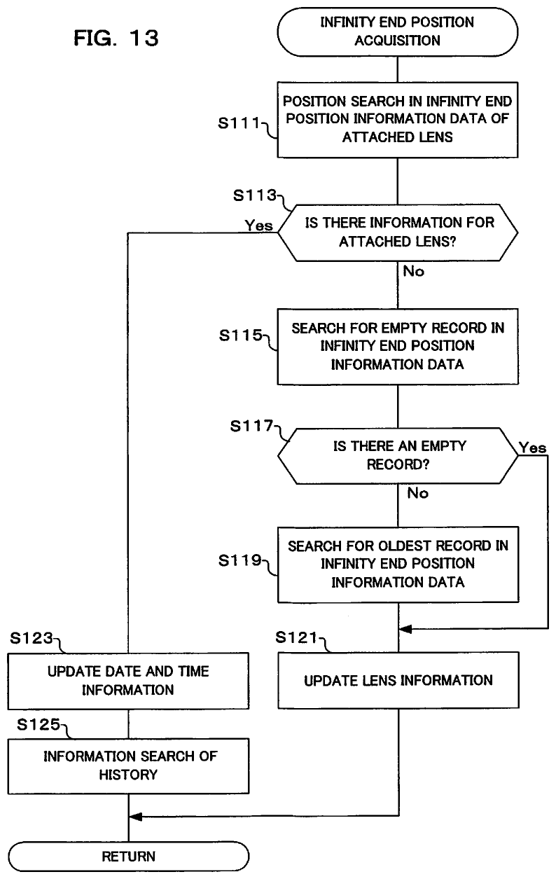

If the flow for exposure condition adjustment processing is commenced, lens drive is first performed in order to acquire determination images (S31). Here, the BCPU 60 drives the focus lens to an initial position where determination images are acquired in order to adjust exposure conditions (determination image acquisition lens drive). Regarding this initial position for lens drive, in a case where there is a condition that an in-focus position was detected previously, the lens is driven with that position as the initial position, while if an in-focus position was not detected previously the lens is driven with a predetermined position as the initial position. In a case where it has been determined that there is reliability at the time of in-focus position detection, in the flow for infinity end position registration shown in FIG. 14, a previous in-focus position is stored in non-volatile memory, together with a zoom position, in-focus position that has been detected, and a value representing reliability, for every lens type. Then, in a case of shooting with the same conditions (same lens type, same zoom position etc.) the BCPU 60 reads out information for that in-focus position from the non-volatile memory, and moves the focus lens to that in-focus position. Reading out of this lens initial position (in-focus position) is performed based on type of interchangeable lens 12 that has been fitted, zoom position etc., in accordance with the flow for infinity end position acquisition shown in FIG. 13.

If lens drive for acquiring determination images is complete, next, images for determination are required (S33). Here, the image sensor within the image sensor unit 54 acquires images for determination, and outputs to the BCPU 60 by means of the image sensor interface circuit 61. If images for determination have been acquired, brightness values of pixels within an AF target are detected. A Bayer array has R pixels, Gb·Gr pixels and B pixels, with RAW (RGbGrB) image data being generated based on each pixel output, and converted from RAW image data to luminance image data. As a method of converting to a luminance image, for example, calculation may be performed using 4 pixel additive averaging image data (Y=(R+Gb+Gr+B)/4) etc.

If images for determination have been acquired, it is next determined whether or not it is necessary to perform exposure again (S35). Here, the BCPU 60 determines whether or not images for determination that have been acquired are suitable for photometric value calculation (brightness information acquisition). In the event that image data of images for determination that have been acquired is equivalent to images that are too dark, then that image data is not suitable for calculation of photometric values and so it is determined that it is necessary to perform exposure again. In this case, processing advances to step S43 which will be described later.

If the result of determination in step S35 is that it has been determined that it is not necessary to perform exposure again, next, photometric value are calculated (S37). Here, photometric value calculation is performed based on images for determination that were required in step S33, and brightness information (photometric values) of the images for determination is acquired.

If photometric value have been calculated, next, starry scene/night scene determination is performed (S39). Here, the BCPU 60 determines whether a scene that is being shot is a starry scene, or a moon or night scene, based on brightness information (photometric values) that has been calculated in step S37. Specifically, a starry scene is determined if photometric values are less than or equal to predetermined values. Next it determined whether or not there is starry scene shooting (S41). Here, the BCPU 60 determines whether or not there is starry scene shooting based on determination results in step S39.

If the result of determination in step S39 is not starry scene shooting, specifically in the case of moon or night scene shooting, exposure conditions for moon or night scene are set (S45). Here, the BCPU 60 sets exposure conditions that are suitable for shooting the moon or a night scene.

On the other hand, if the result of determination in step S39 is starry scene shooting or if the result of determination S35 is that it has been determined that it is necessary to perform exposure again, exposure condition setting processing is performed (S43). Here, the BCPU 60 performs processing in order to set exposure conditions that are suitable for starry scene shooting. Specifically, the BCPU 60 adjusts exposure conditions based on whether there are greater than or equal to a fixed number of pixels that are saturated within images for determination that were acquired in step S33, and whether or not a brightness maximum value is appropriate etc., and sets a re-exposure flag to 1 or 0. Detailed operation of this exposure condition setting processing will be described later using FIG. 5.

If the processing of steps S43 and S45 has been executed, it is next determined whether or not it is necessary to perform exposure again (S47). In the event that exposure condition setting for moon or night scene was performed in step S45, the BCPU 60 determines it is not necessary to perform exposure again in this step S47. On the other hand if exposure condition setting processing was performed in step S43, in this step the BCPU 60 performs determination based on the re-exposure flag. It should be noted that if it is necessary to perform exposure again, the re-exposure flag is set to “1” in steps S59 and S67 of FIG. 5.

If the result of determination in step S47 is that it has been determined that it is necessary to perform exposure again, processing returns to step S33, images for determination are acquired again with exposure conditions that were determined in step S43 set again, and the above described processing is performed. These processes are then repeated until it is no longer necessary to perform exposure again (until there is a determination of No in step S47). On the other hand, if the result of determination in step S47 is that it has been determined that it is not necessary to perform exposure again the flow for exposure condition adjustment processing is terminated the originating flow is returned to.

Next, operation of the exposure condition setting processing of step S43 (refer to FIG. 4) will be described using the flowchart shown in FIG. 5. As was described previously, this flow is executed in the event that images for determination are dark or there is starry scene shooting, with exposure conditions being adjusted as required, and if it is necessary to perform exposure again for the purpose of acquisition of images for determination the re-exposure flag is set to 1, and appropriate exposure conditions are finally set.

If the flow for exposure condition setting processing is commenced, first, number of high brightness pixels count processing is executed (S51). Here, the BCPU 60 creates a brightness histogram for images for determination based on brightness values of each pixel of the images for determination that were acquired step S33.

It is then determined whether or not there is saturation (S53). If the number of pixels determined to be saturated (called saturated pixels) within the brightness histogram that was created in step S51 is greater than or equal to a fixed number, it is determined that a taken image has a lot of pixels that are saturated, and the BCPU 60 determines that it is not a suitable image. Saturated pixels are a case where all bits in pixel data have become 1. However, in the determination of step S53, a value close to saturation may be determined, and saturated pixels may be determined in cases of pixel data of greater than or equal to this value.

If the result of determination in step S53 is that there is saturation, exposure conditions are adjusted (S65). Here, the BCPU 60 adjusts exposure conditions so as to perform shooting to make a taken image darker, in order to ensure that pixel signals are not saturated. For example, exposure conditions are adjusted such as lowering ISO sensitivity and shortening exposure time. Once exposure conditions have been adjusted, next, the re-exposure flag (flg_re_exp) is set to 1 (S67).

On the other hand, if the result of determination in step S53 is not saturation, it is determined whether or not a brightness maximum value is suitable (S55). Here, the BCPU 60 determines whether or not a brightness maximum value of a taken image has become greater than or equal to a predetermined brightness value, based on the brightest histogram that was created in step S51. Even if the image data of an image for determination does not become saturated, if an image is dark it will be not suitable for AF determination (point light source AF processing). Accordingly, as a determination reference for this step it is preferable to determine whether or not there is a brightness value that is suitable for performing AF determination (point light source AF processing).

If the result of determination in step S55 is that the brightness maximum value is not suitable, exposure conditions are adjusted (S57). In this case, since the taken image is dark the BCPU 60 performs exposure condition adjustments so as to perform shoot that makes a taken image brighter. As exposure condition adjustment, for example, exposure time is lengthened by a specified amount. Once exposure conditions have been adjusted, the re-exposure flag (flg_re_exp) is next set to 1 (S59).

If the result of determination in step S55 is that the brightness maximum value is suitable, exposure conditions are set (S61). The “exposure condition setting” of this step is processing to define exposure conditions. Once exposure conditions have been set, the re-exposure flag (flg_re_exp) is cleared (=0) (S63), and it is determined that it is not necessary to perform exposure again.

If the re-exposure flag has been set to 1 or reset to 0 in step S59, S63 or S67, the flow for exposure condition setting processing is terminated and the originating flow is returned to In this way, in the exposure condition setting processing, if it is necessary to perform exposure again (re-exposure flag=1) determination images are acquired again with the shooting conditions that have been adjusted in steps S57 and S65, and it is determined whether or not brightness value is in suitable range (refer to S33 and S35 in FIG. 4). By executing these processes, it is possible to adjust exposure conditions so that brightness of taken images is in a suitable range. This means that when acquiring images for determination for the purpose of performing point light source AF it is possible to set in a suitable brightness value range.

Next, operation of the in-focus position detection processing of step S23 (refer to FIG. 3) will be described using the flowcharts shown in FIG. 6A and FIG. 6B.

If the flow for in-focus position detection processing is commenced, first, initial lens drive is executed in (S71). Here, the BCPU 60 drives the focus lens to an initial position in order to acquire images the purpose of calculating AF evaluation values. The initial lens position is stored in memory in the in-focus position storage processing (refer to S99 in FIG. 6B, and to FIG. 14), as an in-focus position (infinity end position) that was detected when AF was performed previously. In this step, an in-focus position (infinity end position) stored in memory is read out (refer to infinity end position acquisition in FIG. 13), and the focus lens is driven to an initial lens position calculated based on this in-focus position.

If the focus lens has been moved to the initial position, next, lens drive and image acquisition are performed (S73). The BCPU 60 drives the focus lens by a predetermined lens drive amount by means of the LCPU 30, with the initial lens position as a reference. Once lens drive has been performed by a given amount acquisition of an image is performed with the exposure conditions that were set in the exposure condition adjustment processing (refer to S43 in FIG. 4, and S61 in FIG. 5). Once acquisition of the image has been performed brightness values of pixels within an AF target are detected based on the image data.

If an image has been acquired, next, an AF evaluation value is acquired (S75). Here, the BCPU 60 calculates an AF evaluation value for detection of in-focus position based on an image that was acquired in step S73, and stores this AF evaluation value in association with the lens position. A plurality of types of AF evaluation value are calculated. As the plurality of AF evaluation values, there are maximum brightness value within an AF target, number of pixels within an AF target that have a brightness value of greater than or equal to a predetermined threshold value, an integrated value of brightness values of pixels within an AF target that have a brightness value of greater than or equal to a predetermined threshold value, and average value of brightness values of pixels within an AF target that have a brightness value of greater than or equal to a predetermined threshold value. All of these evaluation value may be calculated, evaluation values may be suitably selected and calculated, or other AF evaluation values may be additionally calculated.

If AF evaluation values have been calculated, it is next determined whether or not calculation of in-focus position is possible (S77). As was described previously, in step S73 images were acquired while moving the focus lens by a specified amount, and in step S75 a plurality of types of AF evaluation value are calculated using the images that have been acquired. In this step S77 determination as to whether or not calculation of in-focus position is possible is performed based on whether or not it was possible to acquire a plurality of AF evaluation values required for calculation of in-focus position. If the result of this determination is that calculation of in-focus position is not possible, then processing returns to step S73, the focus lens is moved by specified amount to acquire images, and AF evaluation values are calculated again. Specifically, if the number of AF evaluation values that have been acquired is not enough for the number of data acquired for performing in-focus position detection calculation, then acquisition of images while performing lens drive, and calculation of AF evaluation value, are repeated.

If the result of determination in step S77 is that calculation of in-focus position is possible, in-focus position detection calculation is performed (S79). Since the number of AF evaluation values has reached the number for which in-focus position detection calculation is possible, the BCPU 60 performs in-focus position detection calculation using the AF evaluation values that have been calculated. This in-focus position detection calculation will be described later using FIG. 7 and FIG. 8.

If in-focus position detection calculation has been performed, next, reliability determination during in-focus position detection is performed (S81). With the reliability determination during in-focus position detection, the BCPU 60 determines whether or not there are saturated pixels within an AF area (AF target) at the time of calculating AF evaluation values. If saturated pixels have been detected, the retry condition occurrence flag is set, while if saturated pixels are not detected the retry condition occurrence flag is cleared. In the event that there are saturated pixels, as will be described later, it is determined that retry is necessary (refer to S83 and S91), and in-focus position detection processing is performed again after changing exposure conditions (refer to S35 Yes and S43 in FIG. 4). It should be noted that as this determination as to whether or not there are saturated pixels, it may be determined that there are saturated pixels in the event that pixels having a saturated brightness value within the AF area exist in equal to or greater than a specified number. Also, with the reliability determination during in-focus position detection, reliability determinations (1) to (5), which will be described later, are executed.

If reliability determination during in-focus position detection has been performed, is next determined whether or not a retry condition has occurred (S83). As was described previously, in the event that there were saturated pixels in step S81, a retry flag is set to 1. In this step, the BCPU 60 determines that a retry condition has occurred if the retry flag is set to 1

If the result of determination in step S83 is that a retry condition has not occurred, it is next determined whether or not to continue with acquisition of AF evaluation values (S85). Here, the BCPU 60 continuously performs focus lens drive and acquires images, and whether or not to continue with computational processing for AF evaluation values is determined based on these images. In the event that it was not possible to detect in-focus position in step S79, the focus lens has not reached a predetermined position, and it is determined to continue with computational processing for AF evaluation values. It is also determined to continue with computational processing for AF evaluation values if it has been determined, in the reliability determination during in-focus position detection of step S81, that there is not reliability. If the result of this determination is to continue with computational processing, processing returns to step S73 and the previous described processing is repeated.

On the other hand, if the result of determination in step S85 is to not continue with AF evaluation value acquisition, it is determined whether or not it is possible to detect in-focus position (S87). Here, the BCPU 60 determines whether or not it was possible to detect in-focus position in the in-focus position detection calculation of step S79.

If the result of determination in step S87 is that it was not possible to detect in-focus position, or if the result of determination in step S83 is that a retry condition occurred, it is determined whether or not a retry upper limit has been reached (S89). This determination being performed is a case where pixels were saturated in reliability determination during in-focus position detection, or a case where in-focus position could not be detected, or a case where there was no reliability in the reliability determination after in-focus position detection, and in this case it is a case where the retry flag is set to 1 in order to perform in-focus position detection processing again by changing exposure conditions, or in order to perform in-focus position detection processing again without changing exposure conditions. However, there may be cases where it is not possible to detect in-focus position even if in-focus position detection is performed again many times with change in exposure conditions. In this step, therefore, the BCPU 60 determines whether or not the number of times the retry flag has been set to 1 has reached an upper limit.

If the result of determination in step S89 is that the number of times the retry flag has been set has not reached the retry upper limit, retry is set in a condition flag (S91). If retry has been set in the condition flag, the result of determination in step S25 (refer to FIG. 3) is to return to step S21, and after having adjusted exposure conditions the in-focus position is detected again in step S23. It should be noted that at the time of returning to step S21 and adjusting exposure conditions (refer to the flow FIG. 4), the lens drive of step S31 may be omitted. On the other hand, if the result of determination in step S89 is that the retry upper limit has been reached, then non-focus is set in the condition flag (S93). If non-focus has been set in the condition flag, non-focus processing is executed (refer to S7 and S17 in FIG. 2).

Returning to step S87, if the result of this determination is that it was not possible to detect in-focus position, reliability determination after in-focus position detection is performed (S95). Here, the BCPU 60 performs determination for reliability of in-focus position that has been detected. This reliability determination will be described later using FIG. 9 and FIG. 10.

It is next determined whether or not there is reliability (S97). Here, the BCPU 60 determines whether or not there is reliability based on the reliability determination after in-focus position detection of step S95. If the result of this determination is that there is not reliability processing advances to previously described step S89 and it is determined whether or not the retry upper limit has been reached.

On the other hand, if the result of determination in step S97 is that there is reliability, in-focus position storage processing is performed (S99). Because this in-focus position is focus position information for a starry scene, it can be used as infinity end position information. This position is therefore stored as an in-focus position history every time in-focus position detected, and is used as a reference position for the next and subsequent point light source AF. The reference position is set and used as an initial lens position by being read out from memory, at the time of initial lens drive step S31 (FIG. 4) and step S71 (FIG. 6A). It should be noted that details of the data that is stored in memory at the time of storage processing for the in-focus position are shown in FIG. 12. Also, details of the storage processing for in-focus position in step S99 will be described later using FIG. 14.

If in-focus position storage processing has been performed, next, in-focus is set in the condition flag (S101). If in-focus has been set in the condition flag, it is determined that in-focus position has been detected in step S7 of FIG. 2. If setting of the condition flag has been performed in steps S91, S93, or S101, the flow for in-focus position detection processing is terminated and the originating flow is returned to.

Next, description will be given of the in-focus position detection calculation. The principle of the in-focus position detection calculation is described in patent publication 2, and is based on the fact that a state where symmetry of AF evaluation values is largest corresponds to a focused state. US Patent Application Publication No. US 2018/0120534 which is corresponding to the patent publication 2 is incorporated herein by reference. First, description will be given of a method for detecting symmetry of AF evaluation values that is performed in the in-focus position detection calculation of step S79 (refer to FIG. 6A).

FIG. 7 is a drawing for describing symmetry matching processing (symmetry processing). In FIG. 7 line LS represents AF evaluation values corresponding to focus lens position, and if focus lens positions are made I (horizontal axis), AF evaluation values are shown as G(i) (vertical axis). Also, line LI is an inversion signal that is generated by inverting line LS, with focus lens position k for calculating degree of symmetry S(k) (also called symmetry evaluation value) as an axis of symmetry. On this inversion signal LI, if symmetry calculation position is made k, then for an AF evaluation value G for position k+j, this inversion signal LI is represented by G(k−j). Also, j is changed within a range of width±w required to calculate symmetry S(k) (within a range of window: 2w+1 in FIG. 7), that is, from −w to +w.

A region M(k) is a difference between line LS representing change in AF evaluation value and line LI representing change in the inversion signal. Area of this difference (corresponding to a region M(k)) shows symmetry S(k) graphically. The following equation (1) is used as a parameter for representing symmetry M(k) (specifically symmetry S(k)), based on the viewpoint that position on symmetry axis k where area of region M(k), namely symmetry S(k), becomes minimum is where symmetry is largest. Then, M(k) is calculated while displacing symmetry axis k, and position of k exhibiting a minimum value of M(k) is detected as an in-focus position having the largest symmetry.

$$M ( k ) = {\sum }_{j = - w}^{w} ABS ( G ( k + j ) - G ( k - j ) ) \qquad ( 1 )$$

It should be noted that in equation (1) j and w have the following relationship.

−w≤j≤+w

w≤k≤t−w−1

Also, w represents a section of AF evaluation values used in detection of symmetry, and T represents a number of AF evaluation values. j represents order in which AF evaluation value have been acquired, and calculation of M(k) becomes possible after j=2w+1 AF evaluation values have been obtained. M(k) described above is called symmetry matching result. ABS means absolute value, and ABS(G(k+j)−G(k−j)) is an absolute value of a calculation result for (G(k+j)−G(k−j)).

Next, a method of detecting in-focus position implemented by in-focus position detection calculation (S79 in FIG. 6A) will be described.

FIG. 8 is a drawing showing a method for detecting in-focus position by detecting symmetry of AF evaluation values based on symmetry matching processing. The horizontal axis represents position of the focus lens (LD), and the vertical axis represents brightness value B (for example, maximum brightness value) as one example of an AF evaluation value, and symmetry matching evaluation value (symmetry matching result M(k) (refer to equation (1)) for an AF evaluation value. In the case of having performed symmetry matching processing on brightness value B, which is one example of an AF evaluation value, a symmetry matching result M is obtained. In FIG. 8, only peripheral in-focus position candidates are shown, (only an infinity end reliability evaluation range Rinf and close-up end reliability evaluation range Rclb are shown), but in reality many more data points will exist. Also, in the example shown in FIG. 8, a focus lens position LD=4 where symmetry matching result M becomes a minimum value M(n) is obtained as an in-focus candidate position. In FIG. 8, n of the symmetry matching result M(n) becomes 4. When position symmetry matching result M has decreased two times continuously, and has increased two times continuously, with respect to increase in LD (horizontal axis), position of the minimum value M(n) is made position n where there is a change from a decreasing state to an increasing state. In FIG. 8, an infinity end reliability evaluation range Rinf and a close-up end reliability evaluation range Rclb for symmetry matching result M used at the time of determination of reliability, which will be described later, are shown.

In the in-focus position detection calculation of step S79, position of a minimum value for symmetry matching result M is detected for each of a plurality of types of AF evaluation value. Then, if minimum value M(n) of symmetry matching result M for each types of AF evaluation value occurs at the same position of the focus lens, that focus lens position is determined to be an in-focus position candidate. This is because if it has been detected that symmetry matching results M for a plurality of types of AF evaluation values have minimum values at the same position and a number of the minimum values are greater than or equal to a fixed number, there will be a high possibility of there being an in-focus position of high reliability.

As a plurality of AF evaluation values, maximum brightness value within an AF target, a number of pixels having a brightness value of greater than or equal to a predetermined threshold value, an integrated value of brightness value of pixels having a brightness value of greater than or equal to a predetermined threshold value, an average value of brightness value of pixels having a brightness value of greater than or equal to a predetermined threshold value, etc., are set.

Next, description will be given of the reliability determination after in-focus position detection, of step S95 (refer to FIG. 6B). With reliability determination after in-focus position detection, determination of reliability for minimum values that have been detected by in-focus position detection calculation is performed. That is, the following plurality of types of reliability are evaluated for the purpose of judging whether or not a position of a minimum value that has been detected is suitable as an in-focus position.

(1) Probability of In-Focus Position that has been Detected

Pulse position of an in-focus position that has been detected (focus lens position) is compared with a predetermined value, for example, a design value for pulse position at the optical infinity end, and if the pulse position of the in-focus position is not within a specified range that has the pulse position for the optical infinity as a center, it is determined that there is not reliability. The subject of starry scene shooting mode is astral bodies such as stars, and the astral bodies are at infinity end positions, which means that if the in-focus position that has been detected is not within a specified focus range from the infinity end it will be regarded as erroneous ranging. Pulse position for the optical infinity end is stored in memory. Also, instead of pulse position of the optical infinity end, detected infinity end position data, which will be described later, may also be used.

(2) Positional Relationship Between Minimum Values of a Plurality of Types of AF Evaluation Values

Evaluation as to whether pulse positions (focus lens positions) for minimum values of symmetry matching result for each types of AF evaluation value match is performed. Specifically, a plurality of types of AF evaluation values are calculated, a minimum value for each types of AF evaluation value is obtained, and pulse positions of minimum values for each types of AF evaluation value are compared. For example, if differences between pulse positions of minimum values of a plurality of types of AF evaluation value are not within a threshold value, it is determined that some or all pulse positions for minimum values of the plurality of types of AF evaluation values are not reliable.

(3) Degree of Symmetry of Symmetry Matching Results

Degree of symmetry of symmetry matching results will be described using FIG. 9. In FIG. 9, the symmetry matching results M in the graph of FIG. 8 have been extracted. As references for pulse position minimum values of symmetry matching results M, if an evaluation parameter value where pulse position is close to 0 (Rinf) is made E1, and an evaluation parameter value for the opposite side (Rclb) is made E2, then E1 can be calculated using equation (2) below, and E2 can be calculated using equation (3) below.

E1=max(M(i−1)−M(i))/(max(M(i))−min(M(i))) (2)

Here, i=n, n−1, . . . n−N+1

E2=max(M(j+1)−M(j))/(max(M(j))−min(M(j))) (3)

Here, j=n, n−1, . . . n−N+1

Also, N represents an evaluation section (FIG. 9 shows an example for a case where n=4 and N=4).

The denominator of equation 2 for calculating evaluation parameter value E1 corresponds to E1d in FIG. 9, and the numerator corresponds to E1n in FIG. 9. Similarly, the denominator of equation 3 for calculating evaluation parameter value E2 corresponds to E2d in FIG. 9, and the numerator corresponds to E2n in FIG. 9. Accordingly, the evaluation parameter values E1 and E2 represent rate of maximum change amount corresponding to one section with respect to change amount of an evaluation section. If a difference between the evaluation parameter values E1 and E2 is greater than or equal to a fixed value, then symmetry of the symmetry matching results M is not good, and so it is determined that they are not reliable.

(4) Degree of Sharpness in Vicinity of Minimum Value of Symmetry Matching Result

Degree of sharpness of symmetry matching results close to a minimum value will be described using FIG. 10. FIG. 10 shows an example in which the symmetry matching results M in the graph of FIG. 8 are extracted, and a difference (absolute value) between adjacent symmetry matching results is made an evaluation parameter value. With pulse position n of a minimum value M(n) as a reference, evaluation parameter values at a side where pulse position is close to 0 are made La_X, and evaluation parameter values on the opposite side are made Lb_X. Within the evaluation parameter values La_X, La10, La21 and La32 are set in order moving towards a minimum value pulse position, while within the evaluation parameter values Lb_X, Lb32, Lb21, and Lb10 are set in order moving away from the minimum value pulse position. It is determined that there is no reliability if these evaluation parameter values are smaller than a predetermined value. Also, La10, La21 and La32, and Lb 32, Lb21 and Lb10, respectively, are divided by larger values among two corresponding symmetry matching results, to calculate La32′, La21′ and La10′ using equations (4) to (6) below, and Lb32′, and calculate Lb21′ and Lb10′ using equations (7) to (9) below.

La32′=(M(n−2)−M(n−3))/M(n−3) (4)

La21′=(M(n−1)−M(n−2))/M(n−2) (5)

La10′=(M(n)−M(n−1))/M(n−1) (6)

Lb32′=(M(n+2)−M(n+3))/M(n+3) (7)

Lb21′=(M(n+1)−M(n+2))/M(n+2) (8)

Lb10′=(M(n)−M(n+1))/M(n+1) (9)

Based on the above described evaluation parameter values, rate of change of corresponding symmetry matching results is evaluated, and no reliability is set if the rate of change is greater than or equal to a negative fixed value.

(5) Relationship of Minimum Values of Symmetry Matching Values, Between AF Evaluation Values

A plurality of types of AF evaluation value are grouped, in-focus positions that have been detected within each group are compared between groups, and no reliability is set if an in-focus position is not detected across a plurality of groups. This reliability determination will be described using FIG. 11A to FIG. 11D. With this example, images are acquired by changing focus (horizontal axis) and respective calculation is performed for AF evaluation values 1 to 4, symmetry matching of these AF evaluation values is respectively calculated, and results of that pattern matching are obtained as calculations results 1 to 4. AF evaluation values 1 to 4 are set as group 1 shown in FIG. 11A, and AF evaluation values 2 to 4 are set as group 2 shown in FIG. 11B to FIG. 11D.

With the example shown in FIG. 11A to FIG. 11D, a minimum value for calculation result 2 (symmetry matching result) is detected at point PA in AF evaluation value 2 (calculation result 2) of group 2 (refer to FIG. 11B), but a minimum value is not detected for point PA in FIG. 11A for calculation result 1 (symmetry matching result) of AF evaluation value 1 of group 1. As a result, reliability of the minimum value for point PA is judged to be low, and an AF operation (acquiring images while changing focus) continues. Then, since a minimum value of calculation results is detected in both groups for point PB, is judged that the minimum value for point PB has high reliability, and the focus position for point PB becomes an in-focus position.

It should be noted that in the example shown FIG. 11A to FIG. 11D, calculation result 1 based on AF evaluation value 1 is made group 1, and calculation results based on other AF evaluation values are divided into group 2. Which calculation results to make group 1 may be appropriately selected. Also, calculation results may not particularly be divided into groups, and for calculation results based on all AF evaluation values reliability may be judged with equal weighting.

Reliabilities of (1) to (5) described above are evaluated in step S95 (refer to FIG. 6B). Based on the result of this evaluation, whether or not there is reliability for the in-focus position that has been detected is determined in step S97. The judgment of reliability in this case may be that if it is judged that there is not reliability for a plurality of (1) to (5) described above, it is judged overall that there is not reliability, and it may be that if there is not reliability for one among (1) to (5) described above it is judged that there is not reliability overall. Further, determination may be performed by appropriately selecting from among (1) to (5) described above. Still further, any of (1) to (5) described above may be made essential conditions, and other selective conditions may also be set. Whichever approach is taken, overall judgment may be performed by appropriately combining judgment conditions for reliability.

If the result of determination in step S97 is that it is has been judged that there is not reliability, it is determined in step S89 whether or not the number of retries has reached an upper limit. If the result of this determination is that the number of retries has not reached the upper limit, retry is performed (S91→S25: Y). On the other hand, if the upper limit has been reached (S89: Y), AF is completed with non-focus (S93→S25: N→S7: N→S17). It has been described that the reliability determination processing (1) to (5) as described above is executed during reliability determination after in-focus position detection (FIG. 6B, S95). However, this is not limiting, and it is possible to execute the determination processing of (1) to (5) in the reliability determination during in-focus position detection of step S81 in FIG. 6A. In this case, when reliability is low acquisition of evaluation values is made to continue, and by setting that there is no occurrence of a retry condition it is possible to continue in-focus position detection calculation (S79) (S83: No, S85: Yes, S73 in FIG. 6A).

Also, in a case where it is been determined that there is reliability in step S97, in-focus position storage processing is performed (S99). In this step, it is confirmed whether or not an in-focus position history of conditions for which point light source AF was performed has been stored within the camera. In a case here such history is not stored within the camera storage is newly performed, while if the history is already stored data that is stored is compared with reliability of in-focus position that has been detected this time, and data is overwritten if reliability of the in-focus position detected this time is high.

With the in-focus position storage processing of step S99, every time an in-focus position is detected, in-focus position is stored as a history of in-focus position corresponding to infinity end position information, and used as a reference position with the next and subsequent AF. This reference position is read out from memory at the time of initial lens drive (S31 in FIG. 4, and S71 in FIG. 6A), and use for setting of initial lens position. An example of data that is stored in history information that includes in-focus position is shown in FIG. 12.

Next, processing for infinity end position acquisition will be described using the flowchart shown in FIG. 13. This processing performs retrieval processing in the body side memory, and obtains infinity end position data. Specifically, searching of a data region within memory and a function to update the data region are combined, and infinity end position data corresponding to a zoom value of an interchangeable lens 12 that has been fitted is acquired. This processing, or infinity end position data that has been acquired, is used when obtaining initial position of the focus lens in step S31 of the exposure condition adjustment processing shown in FIG. 4, and in step S71 of the in-focus position detection processing of FIG. 6A.

If the flow for infinity end position acquisition in FIG. 13 is commenced, first, position is searched for in the infinity end position information data of the attached lens (S111). Here, the BCPU 60 acquires lens ID, serial No., and lens FW (firmware) version of the interchangeable lens 12 that has been fitted to the camera body 11 from the interchangeable lens 12, and searches for a record number (corresponding to address) in the memory (for example, flash ROM 64) that stores the infinity end position information data, based on these items of information. As a result of this searching, if there is a record number that matches the lens ID etc. then that record number is output, while if there is not a matching record an invalid value (−1) is set in the record number, and the record number of −1 is output.

It is next determined whether or not there is information for the attached lens (S113). As was described previously, at the time of the searching of step S111, if there was infinity end position information data matching the lens ID etc. of the attached lens then that record number was output, while if there was no matching infinity end position information data an invalid value (−1) is output as the record number. The BCPU 60 therefore performs determination based on the record number that has been output in step S111.

If the result of determination in step S113 is that there is information for the attached lens, update of data information is performed (S123). Here, date and time information (“access data and time” in FIG. 12) of data corresponding to the matching record number, in the infinity end position information data, is updated and stored. As will be described later, when storing infinity end position information and history information in memory (refer to S121 and S133), the date of information update for that record is stored. In this step S123, since there was attached lens information, date and time information is updated. It should be noted that in a case where there are no empty records, a record having the oldest date and time information is overwritten (refer to S119 in FIG. 13).

On the other hand, if the result of determination in step S113 is that there is no attached lens information, an empty record is search for in the infinity end position information data (S115). Here, the BCPU 60 searches for an empty record in which infinity end position information is not stored, in the memory that stores infinity end position information data. When infinity end position information data is stored in memory, date and time of data update is stored (refer to S121 and S123). In retrieving an empty record, a record that has a default value (for example, “0”) stored as date and time of update may be retrieved. If the result of this retrieval is that there is an empty record that record number is output, while there if there is no empty record an invalid value (−1) is set in the record number, and that record number is output.

It is next determined whether or not there is an empty record (S117). Here, the BCPU 60 determines whether or not there is an empty record in which infinity end position information data is not stored, based on the result of retrieval in step S115.

If the result of determination in step S117 is that there is no empty record, the oldest record is searched for in the infinity end position information data (S119). As has been described above, date and time information for when data was initially stored, or date and time information for when update was performed (“access time and date” in FIG. 12), is stored in the infinity end position information data for every record number. The oldest time and date information is therefore searched for within this time and date information that is stored for every record number. Once search is complete, the record number (rec_no) of the oldest record is output.

If the oldest record has been retrieved in step S119, or if the result of determination in step S117 was that there was an empty record, lens information is updated (S121). If a result of having performed search in step S115 is that there is not an empty record, the oldest record is found in step S119 and lens information of the oldest record updated. As updates to lens information there are, for example, in addition to update of date and time information similarly to step S123, update to lens ID, serial No., and lens FW (firmware) version of the interchangeable lens 12. If lens information has been updated, processing returns.

Once date and time information has been updated in step S123, history information retrieval is next performed (S125). Here, the BCPU 60 retrieves history data in the interchangeable lens 12 that has been fitted, and corresponding to current zoom value, in the infinity end position information data. Record number, zoom value, number of zoom partitions, and infinity end position information data of the attached lens are input, and detected infinity end position corresponding to zoom value, and reliability of information on infinity end position, are output.

In the event that there was information on the attached lens in step S113, a record number is output. In this step S125, data corresponding to current zoom value of the interchangeable lens 12 that has been fitted is retrieved from within the record number that has been output. Confirmation that infinity end position information corresponding to this zoom value exists is performed by checking information on reliability that is stored in correspondence with zoom value.

Processing of results of retrieval of infinity end position information corresponding to zoom value will be described giving three cases, case 1 to case 3.

(Case 1) when Data Corresponding to Zoom Value Exists

In the event that infinity end position information corresponding to the current zoom value is stored in the infinity end position information data, the BCPU 60 reads out and outputs detected infinity end position and reliability that are stored in memory.

(Case 2) when Data Corresponding to Zoom Value does not Exist

In this type of case, the BCPU 60 first retrieves data that is stored with a zoom value close to the current zoom value (also called neighboring data), in the following order. A retrieval range is set to the following conditions, and data that has a reliability that is not 0, specifically, in-focus position that has been acquired previously, is retrieved one point at a time in the following ranges (a) and (b), and data that has been found is made neighboring data p11 and p12.

zoom value-RANGE_SEARCH≤retrieval range 1<zoom value (a)

zoom value<retrieval range 2≤zoom value+RANGE_SEARCH (b)

It should be noted that RANGE_SEARCH is retrieval range.

In the case of retrieval for (a) described above retrieval is performed in the order of zoom value−1, zoom value−2, . . . , and in the case of retrieval for (b) retrieval is performed in the order of zoom value+1, zoom value+2, . . . , and retrieval is completed at the point where neighborhood data has been found. In the event that neighborhood data was not found by searching one point at time in either of the retrieval ranges (a) and (b), processing is performed using case 3 which will be described next.

If neighborhood data was found by searching one point at time in the above described retrieval ranges (a) and (b), data corresponding to zoom value is calculated by interpolation using neighborhood data of these two points, specifically, by linear approximation of detected infinity end positions corresponding to zoom value. As a processing result for case 2, detected infinity end position=interpolation calculation value, reliability=0, are output. It should be noted that in a case where the interchangeable lens 12 that has been fitted is a fixed focal length lens, the above-described retrieval is not performed.

(Case 3) when Data Corresponding to Zoom Value does not Exist (Neighborhood Data Also does not Exist)

Ina case where a result of having searched memory is that neither data corresponding to zoom value (infinity end position information) or neighborhood data exist, the BCPU 60 outputs, for example, detected infinity end position=0, reliability=0, as a processing result.

If the history information retrieval of step S125 has been completed, the flow for infinity end position acquisition is terminated and the originating flow is returned to.

Execution timing for infinity end position acquisition processing shown in FIG. 13 is that immediately after having commenced point light source AF (star AF control) the processing of step S31 (refer to FIG. 4) is performed, and information on infinity end position that has been acquired is repeatedly used when computing a drive target at the time of driving the focus lens to an initial position. It should be noted that with this embodiment description has been given for obtaining infinity end position by performing retrieval processing in memory at the camera body side, but this is not limiting and retrieval processing may also be performed by the LCPU 30 within the interchangeable lens 12, in a memory region of the memory within the lens.

Next, processing for infinity end position registration will be described using the flowchart shown in FIG. 14. In this flow, functions of searching a data region, and updating the data region, are combined, to perform update for data corresponding to current zoom value of the interchangeable lens 12 that has been fitted, in the infinity end position information data.

This infinity end position registration processing updates information when the following conditions are satisfied.

(1) In a case where data for a zoom value that corresponds to infinity end position information has not been registered, or
(2) in a case where reliability of data (detected infinity end position) that has been registered in infinity end position information is low, specifically, when condition flag=in-focus results from the point light source AF processing of step S5 in FIG. 2 (refer to S101 in FIG. 6B), or in a case where a result of determination for in-focus position detection in step S7 is that in-focus position has been detected, this processing may be executed.

If the flow for infinity end position registration shown in FIG. 14 is commenced, first, update of lens information is performed (S131). Here, the BCPU 60 updates lens information, such as infinity end position information of the interchangeable lens 12 that is attached, in the memory within the camera body 11. In order to update lens information, record number of the attached lens, access date and time, lens ID of the attached lens, serial No. of the attached lens, lens FW version, and infinity end position information data are input.

When updating lens information, processing differs for a case when there is an empty record for storing lens information in memory, and a case where there is not an empty record, as described below.

(1) When there is an Empty Record

Update date and time stored in the record number (corresponding to address) of the interchangeable lens is updated with the date and time of access.

Lens ID stored in correspondence with the record number of the interchangeable lens is updated with lens ID of the interchangeable lens has been fitted.

Serial No. stored in correspondence with record number of the interchangeable lens is updated with serial No. of the interchangeable lens that has been fitted.

Lens FW version stored in correspondence with the record number of the interchangeable lens is updated with lens FW version of the interchangeable lens has been fitted.

(2) When there is not an Empty Record

Update date and time stored in correspondence with the record number of the interchangeable lens is updated with the date and time of access.

Lens ID stored in correspondence with the record number of the interchangeable lens is updated with lens ID of the interchangeable lens has been fitted.

Serial No. stored in correspondence with record number of the interchangeable lens is updated with serial No. of the interchangeable lens that has been fitted.

Lens FW version stored in correspondence with the record number of the interchangeable lens is updated with lens FW version of the interchangeable lens has been fitted.

Detected infinity end position and reliability stored in correspondence with record number of the interchangeable lens are all cleared to 0 (returned to initial state). Since detected infinity end position and reliability are stored for each of a plurality of zoom values in correspondence with a single record number, all zoom values are returned to their initial state.

Once lens information has been updated, update of history information is performed (S133). Here, the BCPU 60 registers in-focus position that has been detected as detected infinity end position. When performing this registration, record number of the interchangeable lens that has been attached, zoom value, in-focus position (detected infinity end position), and reliability at the time of in-focus position detection are input.

As update to history information, detected infinity end position that is stored content of the record number of the attached interchangeable lens, and that is stored in correspondence with zoom value of the interchangeable lens that has been attached, is updated to an in-focus position that is a new detected infinity end position. Also, reliability, that is stored content of the record number of the attached interchangeable lens, and stored in correspondence with zoom value of the attached lens, is updated to reliability at the time of in-focus position detection. It should be noted that respect to initialization of a data region, for example, a region that contains infinity end position information data is initialized to 0 as an unused region at the time of camera manufacture.

Once history information has been updated, update of date and time information is performed (S135). Here, the BCPU 60 updates date and time information of infinity end position information data for the interchangeable lens that has been attached. In other words, date and time at which the interchangeable lens was attached and a point light source AF was issued is stored. Record number of the interchangeable lens buttons been attached, access date and time, and infinity end position information data are input, and update date and time of the record number of the attached lens for infinity end position information data are updated using access date and time. If update of date and time information as being performed, the flow for infinity end position registration is terminated and the originating flow is returned to.

In this way, the lens drive of this embodiment is performed as follows.

(1) If point light source AF is selected, the lens is driven to a position that is registered in infinity end position registration information or to a target position based on that position (refer to S31 in FIG. 4, S71 in FIG. 6A, and to FIG. 13).
(2) During point light source AF execution AF evaluation values are acquired while performing focus lens drive at fixed intervals (refer to S73 and S75 in FIG. 6A).
(3) If the result of having performed in-focus position detection is that in-focus position could be detected, the focus lens is driven to the in-focus position that was detected (refer to S87 and S95 in FIG. 6B).
(4) If the result of having performed in-focus position detection is that in-focus position could not be detected, the focus lens is driven to a position registered in infinity end position registration information (S17 in FIG. 2).

As has been described above, the imaging device of one embodiment of the present invention prevents saturation of brightness value during operations to focus on a subject such as a point light source which is at the infinity end, and evaluates reliability at the time of in-focus position detection. As a result, incidence of false focus in an environment where glimmer (flicker) occurs is suppressed, and it is possible to shoot starry scenes etc. accurately. Specifically, with related art technology disclosed in patent publication 2 there is influence of glimmer (twinkling of stars etc.) due to atmospheric air currents, and a brightness signal changes over time, which means that AF evaluation values are unstable, detection precision of in-focus points based on symmetry matching processing is lowered, and there is a possibility of focus becoming loose. However, according to one embodiment of the present invention accurate in-focus points can be detected even if stars etc. are twinkling.

Also, with one embodiment of the present invention, brightness values of pixels within a specified evaluation region are detected based on image data (refer to S73 in FIG. 6A, for example), evaluation values are calculated based on brightness values (refer, for example, to S75 in FIG. 6A), a parameter representing degree of symmetry of evaluation values for position of focus is calculated, reliability is determined based on this parameter (S95 in FIG. 6B), and focus detection is performed based on an extreme value calculated based on the parameter, and reliability (S97 and S101 in FIG. 6B). As a result, lowering of in-focus position precision due to brightness values being saturated is prevented, and it is possible to suppress unnecessary lens drive and shooting of images, and to perform in-focus position detection at high speed. Specifically, reliability is determined based on a parameter representing degree of symmetry, and focus detection is performed based on this reliability, and so it is possible to prevent lowering of in-focus position precision and is possible to detect in-focus position at high speed.

Also, with one embodiment of the present invention a plurality of different evaluation values are calculated based on brightness values, a plurality of different parameters are calculated based on the plurality of different evaluation values, and it is determined that there is reliability in the event that a difference between focus positions corresponding to extreme values calculated based on the plurality of different parameters is less than or equal to a predetermined value (refer, for example, to S95 and S97 in FIG. 6B, and to FIGS. 11A-11D). Since reliability is determined based on a plurality of evaluation values, it is possible to reduce cases of out of focus.

Also, with one embodiment of the present invention, reliability is determined based on degree of symmetry for extreme values of parameters with respect to position of focus (refer, for example, to S95 and S97 in FIG. 6B, and to FIG. 9). Since reliability is determined based on degree of symmetry, it is possible to perform high reliability focus detection.

Also, with one embodiment of the present invention, reliability is determined based on degree of change in the vicinity of extreme values of parameters with respect to position of focus (refer, for example, to S95 and S97 in FIG. 6B, and to FIG. 10). Since reliability is determined based on degree of change close to extreme values, it is possible to perform high reliability focus detection.

Also, with one embodiment of the present invention, operation to acquire a plurality of image data while changing focus is continued even in a case where it has been determined that some of the plurality of parameters have low reliability (refer, for example, to S85 in FIG. 6A, S95 in FIG. 6B, and to FIGS. 11A-11D. By continuing operation even when some parameters have low reliability, it is possible to detect true in-focus position, and it becomes possible to prevent false focus.

It should be noted that with the one embodiment of the present invention, there are various hardware circuits such as the image processing circuit and image sensor interface circuit 62 within the image processing controller 62, and camera shake correction circuit and shutter control circuit 56 within the camera shake compensation unit 75, but instead of hardware circuits they may also be configured as software using a CPU and programs, may be constructed by hardware circuits such as gate circuits that are generated based on a programming language described using Verilog, or may be configured using a DSP (Digital Signal Processor). These sections and functions may also be respective circuit sections of a processor constructed using integrated circuits such as an FPGA (Field Programmable Gate Array). Suitable combinations of these approaches may also be used. The use of a CPU is also not limiting as long as elements fulfill a function as a controller.

Also, with the one embodiment of the present invention, a device for taking pictures has been described using a digital camera, but as a camera it is also possible to use a digital single lens reflex camera, a mirrorless camera, or a compact digital camera, or a camera for movie use such as a video camera, and further to have a camera that is incorporated into a mobile phone, a smartphone a mobile information terminal, personal computer (PC), tablet type computer, game console etc., or a camera for a scientific instrument such as a medical camera (for example, a medical endoscope), or a microscope, an industrial endoscope, a camera for mounting on a vehicle, a surveillance camera etc. In any event, it is possible to apply the present invention to any device that is for taking photographs by performing AF for a point light source, such as a starry scene, or AF for a subject of a point light source state, such as fluorescent objects that are viewed with a microscope or endoscope.

Also, among the technology that has been described in this specification, with respect to control that has been described mainly using flowcharts, there are many instances where setting is possible using programs, and such programs may be held in a storage medium or storage section. The manner of storing the programs in the storage medium or storage section may be to store at the time of manufacture, or by using a distributed storage medium, or they be downloaded via the Internet.

Also, with the one embodiment of the present invention, operation of this embodiment was described using flowcharts, but procedures and order may be changed, some steps may be omitted, steps may be added, and further the specific processing content within each step may be altered. It is also possible to suitably combine structural elements from different embodiments.

Also, regarding the operation flow in the patent claims, the specification and the drawings, for the sake of convenience description has been given using words representing sequence, such as “first” and “next”, but at places where it is not particularly described, this does not mean that implementation must be in this order.

As understood by those having ordinary skill in the art, as used in this application, ‘section,’ ‘unit,’ ‘component,’ ‘element,’ ‘module,’ ‘device,’ ‘member,’ ‘mechanism,’ ‘apparatus,’ ‘machine,’ or ‘system’ may be implemented as circuitry, such as integrated circuits, application specific circuits (“ASICs”), field programmable logic arrays (“FPLAs”), etc., and/or software implemented on a processor, such as a microprocessor.

The present invention is not limited to these embodiments, and structural elements may be modified in actual implementation within the scope of the gist of the embodiments. It is also possible form various inventions by suitably combining the plurality structural elements disclosed in the above described embodiments. For example, it is possible to omit some of the structural elements shown in the embodiments. It is also possible to suitably combine structural elements from different embodiments.

What is claimed is:

1. A focus detection device, that acquires a plurality of image data while changing focus, and performs focus detection based on the image data, comprising:
a processor having a brightness value detection section, an evaluation value calculation section, a parameter calculation section, a reliability determination section, and a control section, wherein
the brightness value detection section detects brightness values of pixels within a given evaluation region based on the image data;
the evaluation value calculation section calculates evaluation values based on the brightness values;
the parameter calculation section calculates parameters representing degree of symmetry of the evaluation values for positions of the focus;
the reliability determination section determines reliability based on the parameters; and
the control section performs focus detection based on extreme values that are calculated based on the parameters, and the reliability.

2. The focus detection device of claim 1, wherein:
the evaluation value calculation section calculates a plurality of different evaluation values based on the brightness values;
the parameter calculation section calculates a plurality of different parameters based on the plurality of different evaluation values; and
the reliability determination section determines that there is reliability if a difference between the focus positions corresponding to extreme values calculated based on the plurality of different parameters is less than or equal to a predetermined value.

3. The focus detection device of claim 1, wherein:
the reliability determination section determines reliability based on degree of symmetry for the extreme values of the parameters with respect to the focus position.

4. The focus detection device of claim 1, wherein:
the reliability determination section determines reliability based on degree of change in the vicinity of the extreme values of the parameters with respect to the focus position.

5. The focus detection device of claim 2, wherein:
the control section continues operations to acquire a plurality of image data while changing the focus, in a case where the reliability determination section has determined that reliability of some of the plurality of parameters is low.

6. The focus detection device of claim 1, wherein:
the evaluation values are brightness values representing maximum brightness within the evaluation region, a number of pixels that exceed a specified brightness value within the evaluation region, an integrated value of brightness values of pixels that exceed a specified brightness within the evaluation region, or a value derived by dividing the integrated value by a number of pixels that exceed the given brightness value.

7. A focus detection method, that acquires a plurality of image data while changing focus, and performs focus detection based on the image data, comprising:
detecting brightness values of pixels within a given evaluation region based on the image data;
calculating evaluation values based on the brightness values;
calculating parameter representing degree of symmetry of the evaluation values with respect to the position of focus;
determining reliability based on the parameters; and
performing focus detection based on extreme values that have been calculated based on the parameters, and the reliability.

8. The focus detection method of claim 7, wherein:
when calculating the evaluation values, calculating a plurality of different evaluation values based on the brightness values;
when calculating the parameters, a plurality of different parameters are calculated based on the plurality of different evaluation values; and
when determining the reliability, it is determined that there is reliability if a difference between the focus positions corresponding to extreme values calculated based on the plurality of different parameters is less than or equal to a predetermined value.

9. The focus detection method of claim 7, wherein:
when determining the reliability, reliability is determined based on degree of symmetry for the extreme values of the parameters with respect to the focus position.

10. The focus detection method of claim 7, wherein:
when determining the reliability, reliability is determined based on degree of change in the vicinity of the extreme values of the parameters with respect to the focus position.

11. The focus detection method of claim 8, wherein:
in a case where the reliability determination has determined that reliability of some of the plurality of parameters is low, operations to acquire a plurality of image data while changing the focus are continued.

12. The focus detection method of claim 7, wherein:
the evaluation values are brightness values representing maximum brightness within the evaluation region, a number of pixels that exceed a specified brightness value within the evaluation region, an integrated value of brightness values of pixels that exceed a specified brightness within the evaluation region, or a value derived by dividing the integrated value a number of pixels that exceed the given brightness value.

13. A non-transitory computer-readable medium storing a processor executable code, which when executed by at least one processor, the processor being arranged within a focus detection device that acquires a plurality of image data while changing focus, and performs focus detection based on the image data, performs a focus detecting method comprising:
detecting brightness values of pixels within a given evaluation region based on the image data;
calculating evaluation values based on the brightness values;
calculating parameters representing degree of symmetry of the evaluation values with respect to the position of focus;
determining reliability based on the parameters; and
performing focus detection based on extreme values that are calculated based on the parameters, and the reliability.

14. The non-transitory computer-readable medium of claim 13, storing further processor executable code, which when executed by the at least one processor, causes the at least one processor to perform a method further comprising:
when calculating the evaluation values, calculating a plurality of different evaluation values based on the brightness values;
when calculating the parameters, calculating a plurality of different parameters based on the plurality of different evaluation values; and
when determining the reliability, determining that there is reliability if a difference between the focus positions corresponding to extreme values calculated based on the plurality of different parameters is less than or equal to a predetermined value.

15. The non-transitory computer-readable medium of claim 13, storing further processor executable code, which when executed by the at least one processor, causes the at least one processor to perform a method further comprising:
when determining the reliability, determining reliability based on degree of symmetry for the extreme values of the parameters with respect to the focus position.

16. The non-transitory computer-readable medium of claim 13, storing further processor executable code, which when executed by the at least one processor, causes the at least one processor to perform a method further comprising:
when determining the reliability, determining reliability based on degree of change in the vicinity of the extreme values of the parameters with respect to the focus position.

17. The non-transitory computer-readable medium of claim 14, storing further processor executable code, which when executed by the at least one processor, causes the at least one processor to perform a method further comprising:
in a case where it the reliability determination section has determined that reliability of some of the plurality of parameters is low, continuing operations to acquire a plurality of image data while changing the focus.

18. The non-transitory computer-readable medium of claim 13, storing further processor executable code, which when executed by the at least one processor, causes the at least one processor to perform a method, wherein:
the evaluation values are brightness values representing maximum brightness within the evaluation region, a number of pixels that exceed a specified brightness value within the evaluation region, an integrated value of brightness values of pixels that exceed a specified brightness within the evaluation region, or a value derived by dividing the integrated value a number of pixels that exceed the given brightness value.
